(19) United States
(12) Patent Application Publication
(10) Pub. No.: US 2021/0228926 A1
(43) Pub. Date: Jul. 29, 2021

(54) Method of Configuring a Fire Locator Device and Method of Operating a Fire Fighting System

(71) Applicant: Minimax Viking Research & Development GmbH, Bad Oldeslos (DE)

(72) Inventors: Klaus HOFMANN, Bad Oldesloe (DE); Joachim BÖKE, Bad Oldesloe (DE); Philipp JAUER, Lübeck (DE); Alexander DERKSEN, Lübeck (DE); Ralf BRUDER, Lübeck (DE)

(21) Appl. No.: 17/153,820

(22) Filed: Jan. 20, 2021

(30) Foreign Application Priority Data
Jan. 24, 2020 (DE) 10 2020 101 705.7

(51) Int. Cl. A62C 37/36; A62C 3/00

(52) U.S. Cl. CPC A62C 37/36; H04L 67/12; A62C 3/00

(57) ABSTRACT

The present invention relates to a method of operating a fire fighting system (1), the fire fighting system (1) comprising a fire locator device (7), and a plurality of stationary fire fighting devices (3a, 3b, 3c, 3d, 3e), each associated with and configured to distribute fire fighting agent within a respective zone (11a, 11b, 210a-e, 310a-h) of an area of operation, wherein the fire locator device (7) comprises at least one housing (2) configured to be mounted at or in proximity of a wall within or in proximity of the area of operation, a plurality of sensor components (5a, 5b, 5c), wherein each sensor component (5a, 5b, 5c) of the plurality of sensor components (5a, 5b, 5c) comprises a plurality of sensor elements (50) sensitive to radiation in a matrix arrangement, and a controller (9) configured to receive sensor signals from the plurality of sensor components (5a, 5b, 5c) for determining a location of a fire (F) within the area of operation, the method comprising associating each sensor element (50) of the sensor components (5a, 5b, 5c) of the fire locator device (7) to at least zero, preferably at most two, zones (11a, 11b, 210a-e, 310a-h) of the area of operation.

The present invention relates to a method of configuring at least one fire locator device and a method of operating a fire fighting system. The present invention applies particularly, without being limited, to the field of residential fire fighting.

A residential sprinkler according to the definition provided in UL 1626 is a sprinkler intended to be installed in residential occupancies and that opens automatically by operation of a heat-responsive releasing mechanism that maintains the discharge orifice closed. Upon operating at a specified temperature, a discharge of water is distributed in a specific pattern and quantity over a designated area. Standards for the installation of sprinklers are defined, for instance, in NFPA 13 R (Residential), NFPA 13 D (Domestic), and EN16925 (Domestic and Residential).

Residential sprinklers are thus actuated by heat and usually discharge fire fighting agent, in particular water, to regions of the protected room far away from the source of the fire, which leads to severe damage caused by water. Currently listed residential sprinklers may cover areas of 20×20 ft. (6, 1×6, 1 m), which means that an even bigger area will be wetted after a sprinkler activation.

A long desire existed therefore to fight fire at specific locations, which correspond to the actual location of the fire or hazard instead of flooding the entire space of protection, for instance the residential room. Expressed differently, the desire existed to fight the fire without collateral damage occurring due to excess discharge to regions, which are not affected by, for instance, the fire. At the same time, the reliability of the system and therefore the safety of operation must not be compromised.

It has therefore been an object of the present invention to provide a method of configuring at least one fire locator device and a method of operating a fire fighting system, which reduces the risk of collateral damage while maintaining high operational safety and reliability.

According to a first aspect, a method of operating a fire fighting system is provided, the fire fighting system comprising a fire locator device, and a plurality of stationary fire fighting devices, each associated with and configured to distribute fire fighting agent within a respective zone of an area of operation, wherein the fire locator device comprises at least one housing configured to be mounted within or in proximity of the area of operation, in particular at or in proximity of a wall at or in proximity of a wall within or in proximity of the area of operation, a plurality of sensor components, wherein each sensor component of the plurality of sensor components comprises a plurality of sensor elements sensitive to radiation in a matrix arrangement, and a controller configured to receive sensor signals from the plurality of sensor components for determining a location of a fire within the area of operation. The method comprises: associating each sensor element of the sensor components of the fire locator device to at least zero, preferably at most two, zones of the area of operation.

The mapping of the sensor elements to zones allows that a corresponding zone, which can correspond to an activated sensor element, be determined as the location of the fire. The correspondence of one sensor element to more than one zone is particularly useful for borders or edges of zones, i.e. regions where two zones border each other.

The fire locator device being mounted within or in proximity of the area of operation is understood as a location of the fire locator device, from which it is possible to observe the area of operation. Expressed differently, the proximity is limited by the capability of the sensor components to effectively monitor the area of operation. In the preferred example of a room, the fire locator device will generally be determined to be placed at a certain height of one of the walls which circumscribe the room.

The sensor elements of the sensor components can also be referred to as individual pixels. Further, the sensor elements of one or more sensor components can be referred to as being in an array-like arrangement. Expressed differently, an array of sensor elements can extend over one sensor component or over a plurality of individual sensor components.

The area of operation is preferably a room of a building, or a part of a room of a building, while in other embodiments also different areas of operation can be protected by the fire locator device. For instance, the fire locator device can also be employed in protecting an area of operation located outside a building, such as a public space or only partly covered structure. Yet, it is important that the fire locator device is mounted at a certain height and position, in order to monitor the predefined area of operation in such a way that sources of infrared radiation can be localized within that space, i.e. fire can be localized within this area of operation.

Preferentially, the housing provides a side view on the area of operation, such that the entire area of operation can be observed, for instance, from a side wall of the area of operation. Expressed differently, the housing is not designed to be mounted in a center of the area of operation, but on a side thereof.

Preferentially, the plurality of sensor components is mounted at a defined position and with a defined orientation with respect to the housing. Thus, no triangulation between the different sensor signals of the sensor components is needed. It is for this reason also preferred to have all sensor components mounted within the same housing. However, in other embodiments, more than one housing can be provided, for instance due to the geometry of the area of operation.

The radiation to which the sensor elements are sensitive preferably include ultraviolet radiation or thermal radiation, in particular infrared radiation. Where the following embodiments and preferred examples are exemplarily described with reference to infrared radiation, the same benefits and advantages can be achieved when sensors sensitive to other of the preferred ranges of wavelengths of radiation, such as ultraviolet radiation or thermal radiation in general, are employed.

In a preferred embodiment the grid of sensor elements of at least one of the sensor components defines a pixel matrix. The transformation is thus determined between the pixel matrix and the plurality of zones.

The transformation, which could also be referred to as a mapping between pixel matrix and plurality of zones, thus ascertains a correspondence between pixels of the pixel matrix defined by the sensor elements of the sensor components and the zones of the area of operation. The transformation can be determined, for example by a controller, using input from the user and/or relying on a predefined configuration. The predefined configuration can take, for instance, geometrical details of the area of operation, e.g. the covered room, into consideration.

In a preferred embodiment, the transformation is determined under consideration of at least one of a spatial angular resolution of the sensor elements of the array sensor, a field of view of the array sensor and a location of the array sensor in the room. Thus, also a distance, angle and other distortion, which effect the field of view of the array sensor with respect to the room are considered.

In a preferred embodiment, a respective one of a plurality of stationary fire fighting devices associated with one of the zones of the area of operation for each of the zones can be activated.

In a preferred embodiment, the step of associating comprises a step of providing a primary matrix and optionally a secondary matrix, wherein each element of the primary and secondary matrices provides a correspondence between one of the sensor elements of the sensor component and one of the zones.

The primary and secondary matrices allow that a single sensor element, which is associated with more than one zone, can invoke the activation of more than one zone using the zone indicated in the primary matrix and the secondary matrix. The use of a primary and secondary matrix is not necessary, also a N-to-M correspondence between a number of N matrices to a number of M corresponding zones or a one-to-one correspondence of sensor element to zone is contemplated. In other examples, also other forms of transforming the pixel matrix to the number of zones can be used.

In a preferred embodiment, the method further comprises sequentially comparing each of the sensor signals from the sensor elements with a corresponding signal threshold, identifying the zone of the area of operation in case at least one of the sensor signals exceeds the corresponding signal threshold, and activating the at least one fire fighting device associated with the located zone.

The sequential comparison facilitates the processing scheme, reduces the processing requirements and eliminates potential errors due to, for instance, parallel processing. In case a primary and secondary matrix is used, the fire fighting devices associated with both the zones identified in the primary and secondary matrix are activated. In a preferred embodiment, at most two zones out of the plurality of zones are activated.

The activation of each zone is connected to a certain necessary flow rate in order to provide sufficient fire fighting agent to the respective zone. Since in this embodiment at most two zones are activated, the dimensions of the system, for instance water pressure and installed tubing, can be reduced. This significantly reduces the installation and maintenance effort of the system.

In a preferred embodiment, the activation of zones is performed according to a sequence of sensor elements exceeding the corresponding signal threshold.

In other words, the activation of zones is in this embodiment implemented as a first come first serve principle. The first zone to be activated corresponds to the zone of the first sensor element exceeding the corresponding threshold. The second zone to be activated will be the zone, which corresponds to the same sensor element but resulting from the secondary matrix (i.e. preferentially using the primary and secondary matrices for zone correspondences) or a further sensor element exceeding the corresponding threshold, which is different from the first activated zone.

Expressed differently, in case a first and a second zone have already been activated, even in case a third zone, corresponding to a further sensor element exceeding the threshold, is to be activated, the first and second zone will continue to be activated. Optionally, a notification, for instance via e-mail or push message, can be issued.

In different embodiments, priority can be given to the zones according to, for instance, sensor positions or by classification of hazardous areas. Thus, high priority zones could be defined, for instance.

According to a further aspect, a method of configuring at least one fire locator device for fighting a fire in an area of operation, in particular a room of a building is provided. The fire locator device comprises at least one housing configured to be mounted within or in proximity of the area of operation, in particular at or in proximity of a wall of the area of operation, a plurality of sensor components, wherein each sensor component of the plurality of sensor components comprises a plurality of sensor elements in a matrix arrangement, wherein the sensor elements are sensitive to radiation and each sensor component covers a field of view of a certain shape, the field of view having a central axis, and a controller configured to receive sensor signals from the plurality of sensor components for determining a location of a fire within the area of operation, The method comprises i) providing a geometry of the area of operation, and ii) determining, based on the provided geometry, at least one of a) a position of the fire locator device within or in proximity of the area of operation, and b) a location and an orientation of the plurality of sensor components within the at least one housing such that a monitoring coverage fulfils a predetermined criterion.

A monitoring coverage is preferentially defined as the total area of observation of the fire locator device relative to the area of operation.

A field of view is the extent of the observable world that is seen at any given moment by the sensor component. More specifically, it is a solid angle through which the sensor component is sensitive to radiation. A shape of the field of view can thus be defined through the opening pattern, e.g. opening cone or opening angles in two orthogonal directions, through which the sensor component is sensitive to radiation. Preferentially, the shape is circular or rectangular, however, a more general shape is of course contemplated.

A central axis is defined as a line linking central points through the opening cone of the sensor component. Expressed differently, the central axis can be defined as the center of the field of view of the sensor component.

Further, the provided geometry preferentially includes angles and space dimensions of the area of operation. Additionally, the geometry preferentially includes objects, more preferentially dimensions and type of these objects, which are present within the area of operation. The geometry can be provided by any means known in the art, for instance, input by a user or downloaded from a storage medium including a server, wherein the geometry is then preferentially provided in a suitable data format.

Since the determination of the location of the fire locator device allows, based on the geometry, to substantially monitor each location within the area of operation, as a result of the configuration method, a location of the fire locator device is obtained, which allows the protection of the area of operation. The location is in particular determined based on the geometry of the area of operation and depends on the configuration and arrangement of the sensor components, for instance the respective orientation relative to the housing.

The determined position is preferentially within or in proximity of the area of operation. In particular, every location which allows a monitoring of the complete area of operation can be considered a location being in proximity of the area of operation.

In a preferred embodiment, each of the central axes of the plurality of sensor components spans an angle of at least 10°, preferentially of at least 20° and in particular of at least 40° with a vertical axis.

In a preferred embodiment, a field of view of each sensor component is rectangular, preferentially quadratic, wherein the field of view further preferably spans an opening angle of at least 45 degrees and in particular at least 60 degrees in a vertical and horizontal direction.

Since the central axis spans a certain angle with the vertical axis, the side view as defined above can be enabled. More specifically, each sensor component has a view with substantially differs from a vertical view and thus can be considered to have a side view.

In a preferred embodiment, the predetermined criterion being exceeding a threshold, preferentially of at least 90%, more preferably of at least 95% and in particular at least 99%.

In a preferred embodiment, a number of fire locator devices and corresponding positions of the fire locator devices within the area of operation, respectively, are determined such that the monitoring coverage fulfils the predetermined criterion.

In a preferred embodiment, a height of the position of the at least one fire locator device over a floor of the area of operation is determined depending on the geometry of the area of operation, in particular of an extension of the area of operation, wherein the height is determined to be in the range of between 1.94 m and 2.74 m, preferably between 2.1 m and 2.5 m, more preferably between 2.3 m and 2.4 m and most preferably 2.34 m above the floor.

In a preferred embodiment, the central axes of all sensor components of one fire locator device are unique, wherein in particular an angle between any two of the central axes exceeds a predetermined threshold, preferably 20°.

The sensor components are preferably arranged on a common base, wherein the base defines unique absolute orientations for the sensor components, respectively. The sensor components can then all be provided with the same relative orientations with respect to the base, while maintaining unique absolute orientations. Thus, assembly of the fire locator device can be facilitated, since all sensor components can be attached to the base in a similar way.

In a preferred embodiment, the absolute orientations of all sensor components of one fire locator device are unique.

In a preferred embodiment, all of the sensor components are arranged in a substantially horizontal plane, wherein one of the sensor components is arranged closer to a front of the housing than the other sensor components.

In a preferred embodiment, the locations and orientations of the sensor components are determined so as to minimize a change of the monitoring coverage with regard to deviations of the real housing position from the determined housing position.

Since in this embodiment the fire locator device is less susceptible to deviations from the mounting position of the housing, a high coverage rate of the area of observation will be achieved even if the mounting position is inaccurate, i.e. deviates from the determined mounting position. Thus, a high reliability can be ensured even if outside factors, e.g. an inaccurate mounting during installation of the fire locator device, occur.

Preferentially, a computer optimization algorithm is employed to determine the susceptibility of the coverage area with regards to a mounting displacement, which is a deviation of the actual or real mounting position of the housing from the determined, ideal housing position. The mounting displacement can be determined as a one-dimensional variable, for instance as a mere distance from the ideal position, or as a two-dimensional variable, taking into account displacements in the vertical and horizontal displacements. Optimization algorithms both for one-dimensional and two-dimensional optimization problems are well known and readily available for the skilled person.

Using the mounting displacement as a variable criterion, the skilled person can optimize the location and orientation of the sensor components in order to reduce the influence of the mounting displacement on the coverage area. Again, suitable optimization algorithms are well known to the skilled person. Further, it should be contemplated that no solution exists, which will make the coverage area independent from the mounting displacement, such that the skilled person also readily selects a suitable stopping criterion for the optimization, wherein a certain susceptibility to the mounting displacement is accepted.

In a preferred embodiment, each sensor component for each fire locator device comprises a predetermined angle of view, wherein a number of sensor components for each fire locator device is determined so that the sum of predetermined angles of view exceeds 180°, preferentially the number is determined to be three, wherein each sensor component further preferentially comprises a thermopile array sensor having more than 4×4 pixels, in particular at least 8×8 pixels, which forms the sensor elements.

It is a finding of the inventors of the present invention that three sensor components comprising, in particular 8×8 pixels, with preferably at least a 60×60 degree field of view is a favourable trade-off between the number of sensor elements and the capability of reliably monitoring an area of operation formed by a standard room, wherein the resolution of the sensor elements is high enough to allow for an accurate positioning of the location of the fire. In other embodiments also sensor components comprising a field of view of at least 180 degrees are contemplated. In such embodiments, provision of a single sensor component can be sufficient to cover an entire area of operation, e.g. a room of a building.

In a preferred embodiment, at least one, preferably all, of the sensor components comprises a thermopile array forming the sensor elements.

A thermopile array is a particularly beneficial selection for the sensor component due to its high reliability and affordable cost. Since the thermopile elements of the thermopile array generate a voltage proportional to the incurring radiation, in particular incurring infrared radiation, a very simple processing of the signal output of the thermopile elements is possible. Thus, overall complexity of the system is kept reasonable.

In a preferred embodiment the thermopile array comprises an array of 8×8 thermopile elements, wherein the number of the plurality of zones is less than the number of thermopile elements, wherein the number of the plurality of zones is in particular four to twenty-five, particularly preferred five including a centrally overlapping zone.

Of course, also higher or lower numbers of thermopile elements and/or zones are contemplated.

In a preferred embodiment, the method further comprises the step of defining a signal threshold for each of the sensor elements of the plurality of sensor components, wherein a signal value exceeding the signal threshold is indicative of a fire, wherein in particular an individual signal threshold is assigned to each of the sensor elements, respectively.

Each sensor element will output a sensor signal, which is indicative of a magnitude of the incoming radiation, in particular the incoming infrared light. Thus, in case a fire is present at a location, which is “seen” by the respective sensor element, the signal must surpass the defined threshold value. Yet, the threshold has to be chosen sufficiently high, in order to decrease the probability of false alarms. Additionally, a double interlock setup with a fire detection device, in particular a smoke detector, will minimize the probability of false alarms in a preferred embodiment. That means an alarm will preferentially occur only if a sensor threshold is exceeded and the externally or internally connected fire detection device goes off.

In this embodiment, an individual threshold per sensor element will be used to set an appropriately high threshold to avoid false alarms due to fixed heat sources as e.g. stove, kettle, fireplace or radiators.

In a preferred embodiment, the method further comprises to additionally mask, i.e. deactivate or ignore/block the sensor signal of at least one sensor element. In a preferred embodiment, masking of sensor elements will alternatively or additionally to using individual thresholds be used to avoid false alarms due to fixed heat sources as e.g. stove, kettle, fireplace or radiators.

Preferentially, each sensor element monitors a specific portion of the area of operation. Thus, there exists a correspondence between a physical portion of the area of operation and the respective sensor element. Based on this correspondence, individual thresholds for each sensor elements can be defined adequately.

In a preferred embodiment, the method further comprises a step of associating each sensor element of the sensor components of the fire locator device to at least zero, preferably at most two, zones of the area of operation.

Each sensor element thus corresponds to a specific location within the area of operation, such that preferentially no space within the area of operation does not have a corresponding sensor element. However, each location within the area of operation can correspond to more than one sensor element, i.e. the sensor elements can overlap. In particular, sensor elements of different sensor components can overlap.

In a preferred embodiment, the method further comprises a step of defining objects in the area of operation including defining a dimension, in particular a height, of the objects, wherein the number and position of the at least one fire locator device is determined based on the objects.

Most significantly, a height of objects in the area of operation impacts the cover area of the fire locator device. For instance, objects can be defined using a graphical user interface in a computer program. Based on the defined objects, the location of the fire locator device can be determined so that the coverage area is optimum.

While in particular the height of the object is most significant for the impact on the field of view of the fire locator devices, also the extension of the objects in the horizontal plane, i.e. width wise and lengthwise, can advantageously be considered.

Objects can thus be a source of error due to radiation emitted by them, for instance in the case of hot objects. Additionally, or alternatively, objects can define a blocking for the fire fighting at the location of the object. For instance, in case a certain susceptible object, for which is not desired or even dangerous in case it gets into contact with fire fighting fluid, is located within the area of operation, the object can be defined so that it will not get subjected to fire fighting fluid.

In a preferred embodiment, the method further comprises the step of corresponding at least one of the sensor elements with each of the objects.

In a preferred embodiment, the objects comprise at least one hot object or non-hazardous fire, wherein a signal threshold for each of the sensor elements corresponding to the hot object or the non-hazardous fire is increased.

Thus, undesired activation as a result of the corresponding threshold of the sensor element being exceeded can be avoided.

In a preferred embodiment, the method further comprises a step of modifying, by means of a user using an interface, in particular a graphical display, of at least one of a configuration and a position of at least one of the defined fire locator devices, wherein a visual feedback of the change in monitoring coverage based on the modification is provided to the user.

According to a further aspect, a fire fighting system is provided, comprising a fire locator device, and a plurality of stationary fire fighting devices, each associated with and configured to distribute fire fighting agent within a respective zone of an area of operation. The fire locator device comprises at least one housing configured to be mounted at a certain height within or in proximity of the area of operation, a plurality of sensor components, wherein each sensor component of the plurality of sensor components comprises a plurality of sensor elements sensitive to radiation in a matrix arrangement, and a controller configured to receive sensor signals from the plurality of sensor components for determining a location of a fire within the area of operation, the system comprising a controller configured to perform the method according to any of the aspects described above.

In the following, further advantageous embodiments which are beneficial in combination with any of the embodiments described above will be described. The fire locator device preferentially comprises a) at least one housing configured to be mounted at a certain height within or in proximity of an area of operation, in particular at a wall or a ceiling of a room of a building, b) at least one sensor component, wherein each sensor component of the at least one sensor components comprises a plurality of sensor elements in a matrix arrangement sensitive at least to radiation, c) a self-test component for validating the operability of the at least one sensor component, and d) a controller configured to validate the operability of the at least one sensor component using the self-test component and to receive sensor signals from the plurality of sensor components for determining a location of a fire within the area of operation.

In a preferred embodiment, the self-test component comprises at least one thermal radiation source such as a heating element, the thermal radiation source being arranged in proximity to at least one of the sensor elements, wherein the controller is configured to validate the operability of at least one of the sensor elements of the sensor components by evaluating a sensor signal response to a heating of the at least one heating element.

In a preferred embodiment, the fire locator device further comprises at least one temperature sensor, preferably a thermistor, for determining a temperature signal representative of a temperature of the area of operation. For example, the temperature sensor can be located within or in proximity of the housing. In other examples, the temperature sensor is provided together with the fire detection device, e.g. the smoke detector, or at a separate location independent from the location of the fire locator device and the fire detection device.

In this embodiment, the temperature sensor can advantageously be employed to guarantee a double interlock system in case the self-test component determines at least one of the sensor elements and/or sensor components inoperable. In case the temperature sensor indicates an increased temperature, for instance exceeding a predefined threshold, while at the same time, for instance, none of the sensor elements indicates the presence of a fire, the fire locator device can nevertheless realise the unusual situation and, for instance, trigger a fire alarm or the like. In this embodiment, it can be expected that the fire is present at the location of the area of operation corresponding to the inoperable sensor element or sensor component. Further preferentially, the fire alarm is triggered only in case the fire detection device, e.g. the smoke detector, indicates the presence of a fire, such that the double interlock system is ensured. Thus, according to this embodiment, the fire locator device incorporates an additional layer of security, wherein a fire can also be detected and reacted to in case at least one of the other components is inoperable.

In a preferred embodiment, the fire locator device further comprising a power supply, the power supply comprising a mains power supply and a fallback power supply, the fallback power supply preferably comprising a battery. Thus, operational safety can be maintained even in periods in which no mains power is available. The fallback power supply applies in particular for higher risk applications.

In a preferred embodiment, the controller is configured to receive an input signal from an external fire detection device, in particular from a smoke detector.

The input signal from an external fire detection device can thus be used to form a double interlock security system. The double interlock system requires two events to occur before water or other fire fighting agent is released from the system. Thus, only in case the fire detection device, in particular the smoke detector, detects a fire and additionally, for instance, a fire is located by the fire locator according to the invention, fire fighting agent, such as water, is permitted to be released.

In a preferred embodiment, the controller is configured to receive an input signal from an internal and/or temperature sensor, in particular from a thermistor. The input signal from the temperature sensor, which is indicative of a temperature of the area of operation, can thus form a double interlock system together with the input signal from the external fire detection device in case at least one of the sensor components and/or the sensor elements is determined to be inoperable. In case an increased temperature is detected, for instance a temperature exceeding a predefined or definable threshold, and the fire detection device indicates the presence of a fire, the fire is determined to be exist in a location corresponding to the inoperable sensor elements/sensor components and appropriate action can be taken. Thus, integrity of the system can be guaranteed even in a period until the inoperable components return to be operable, e.g. have been repaired or replaced.

Even further, it is contemplated to provide two or more fire locator devices in one single room, wherein the two or more fire locator devices can operate cooperatively on the same area of operation or individually.

In a preferred embodiment the system further comprises at least one fire detection device, in particular at least one fire detection device selected from the list consisting of smoke detector, in particular optical beam smoke detector or aspiration smoke detector; flame detector, in particular infrared (IR) flame detector, ultraviolet (UV) flame detector or combined IR/UV flame detector; heat detector; gas detector; or multi-sensor-detector. The controller is configured to control the plurality of fire fighting devices to only provide fire fighting agent to the fire fighting area in case the fire detection device determines the fire.

The fire detection device can thus determine the presence or non-presence of a fire. The fire detection device not necessarily allows for any spatial resolution, i.e. does not need to be able to provide the location of the fire, while it is enough for the fire detection device to detect whether the fire is present or not. Thus, in this embodiment, the detection by the fire detection device presents a requirement for the controller, while the controllable fire fighting devices are only controlled to provide fire fighting agent in case the fire detection device detects the presence of the fire in the room.

Hereinafter, preferred embodiments of the invention will be described with reference to the accompanying drawings in greater detail.

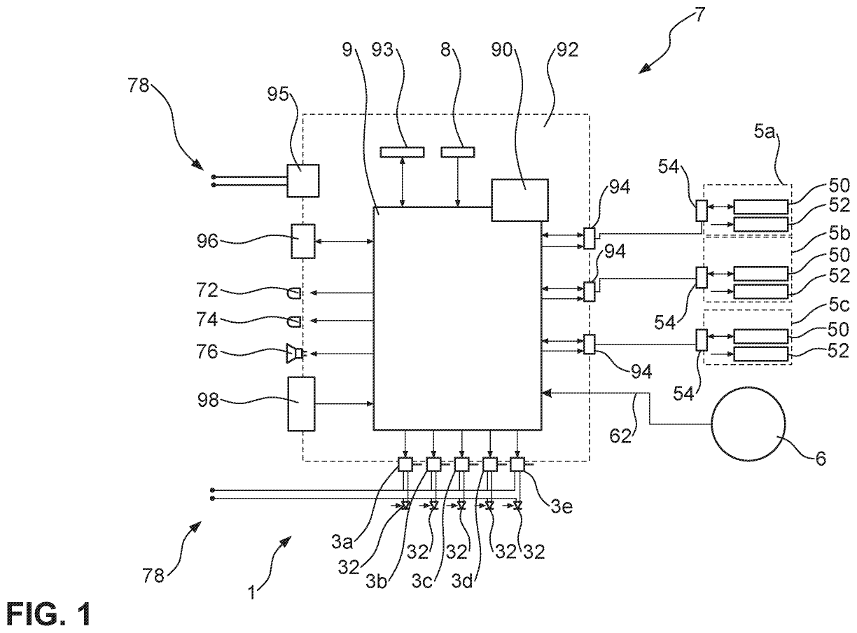

FIG. 1 shows a schematic block diagram of a fire locator device,

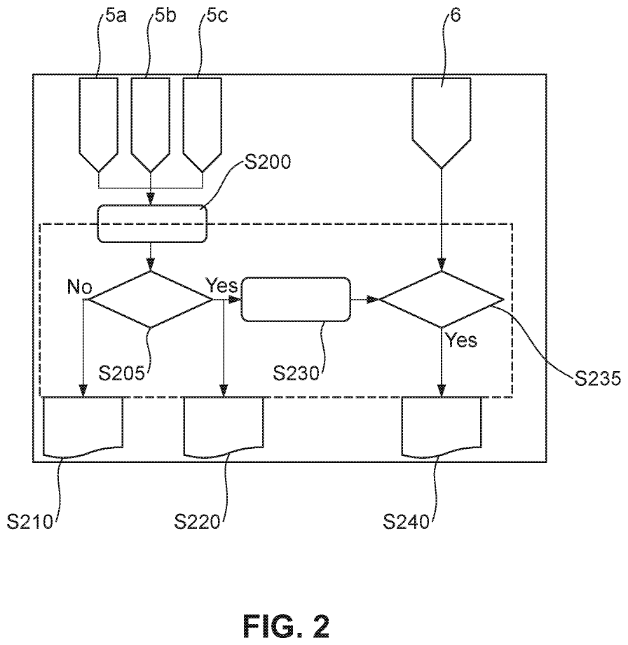

FIG. 2 a schematic flowchart of an operation of the fire locator device shown in FIG. 1,

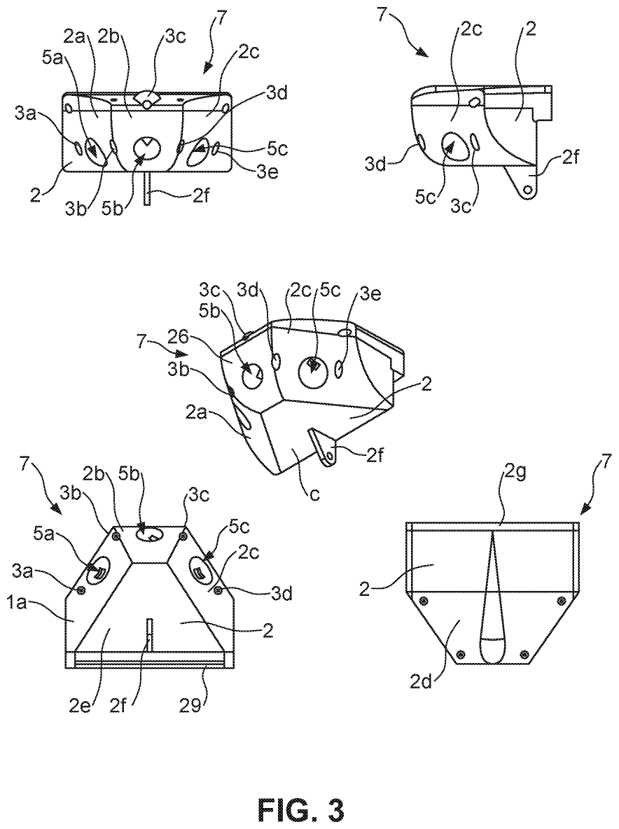

FIG. 3 perspective views of a preferred embodiment of a housing of the fire locator device,

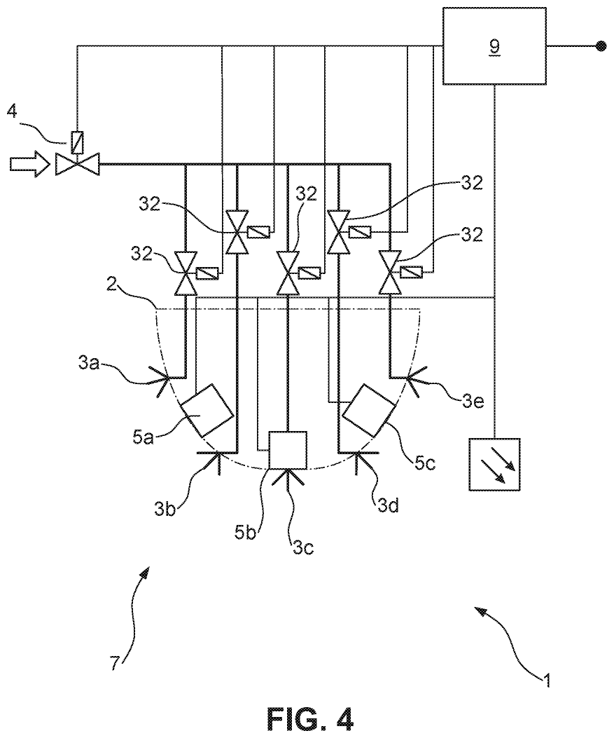

FIG. 4 a schematic view of hydraulics of the fire locator device,

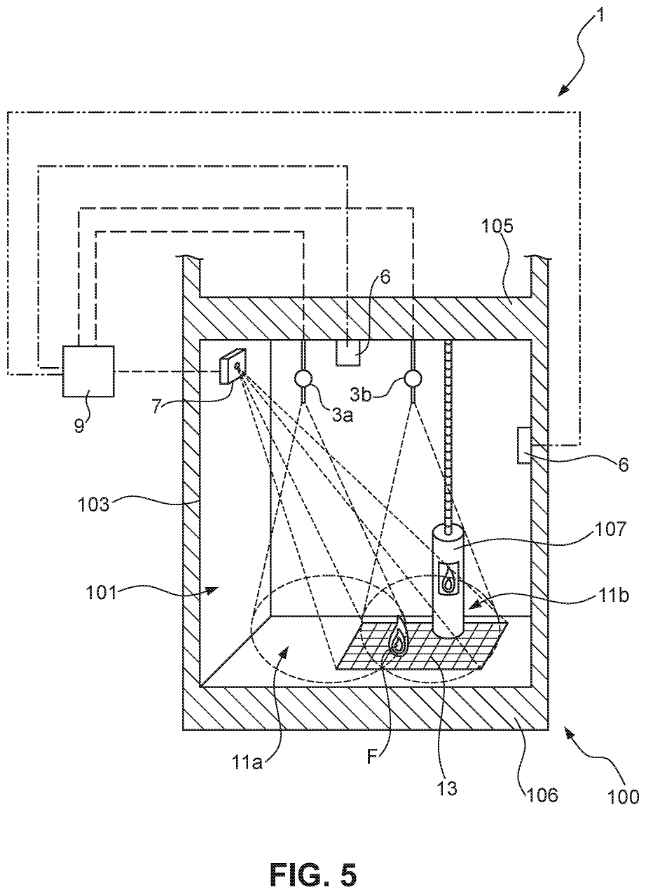

FIG. 5 a schematic view of a fire fighting system,

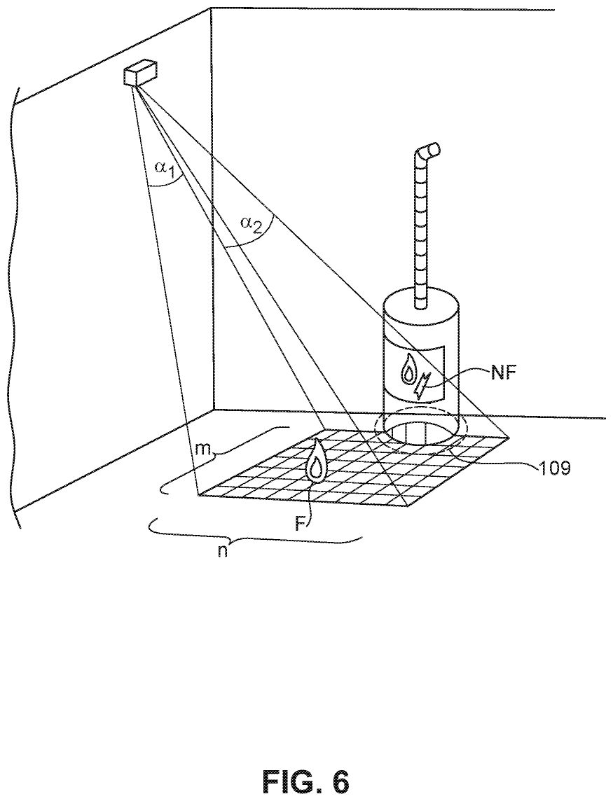

FIG. 6 a schematic detail view of the system according to FIG. 5,

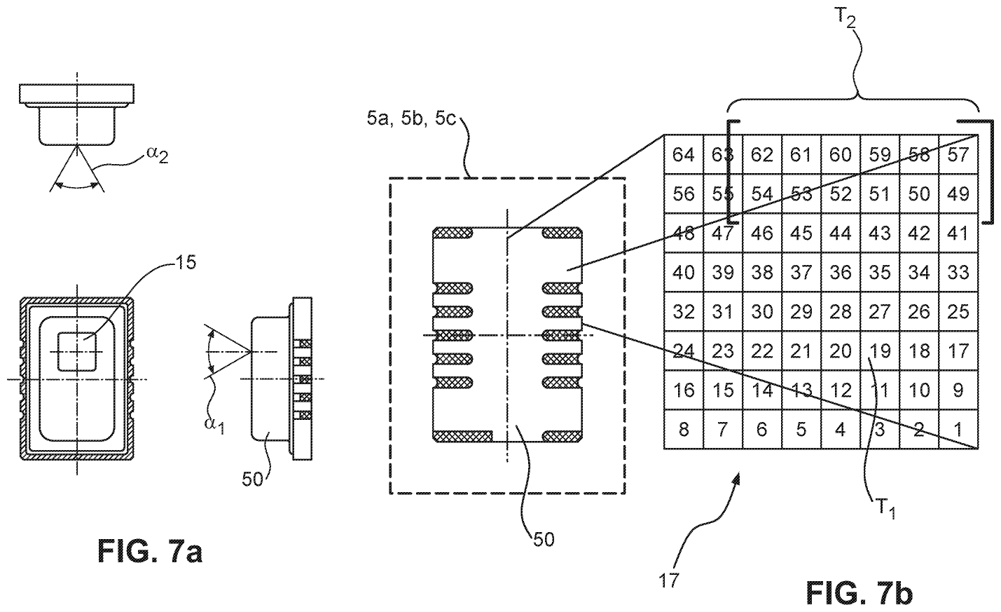

FIG. 7 a, b a schematic detail view of an array sensor used in the system of FIGS. 5 and 6,

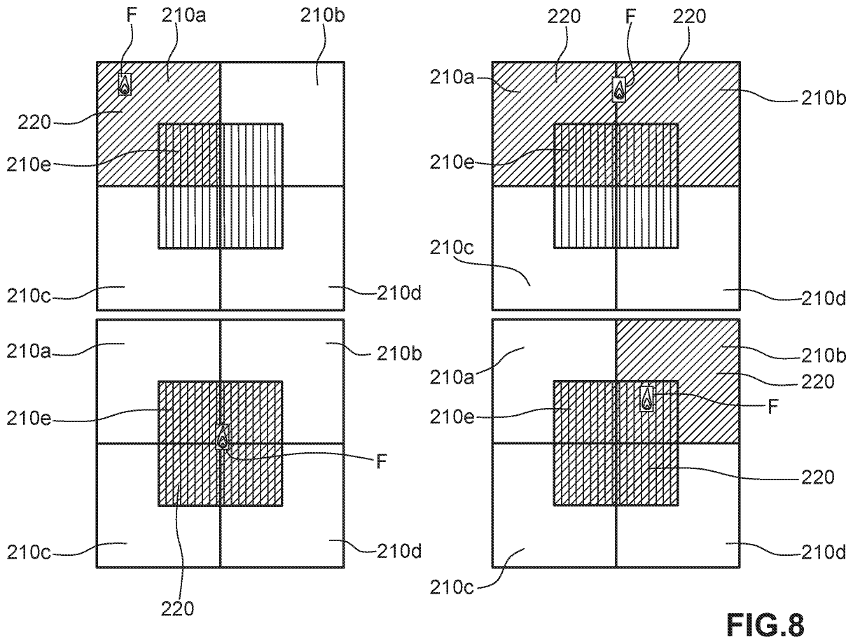

FIG. 8 a schematic view of a first example of zones in a room,

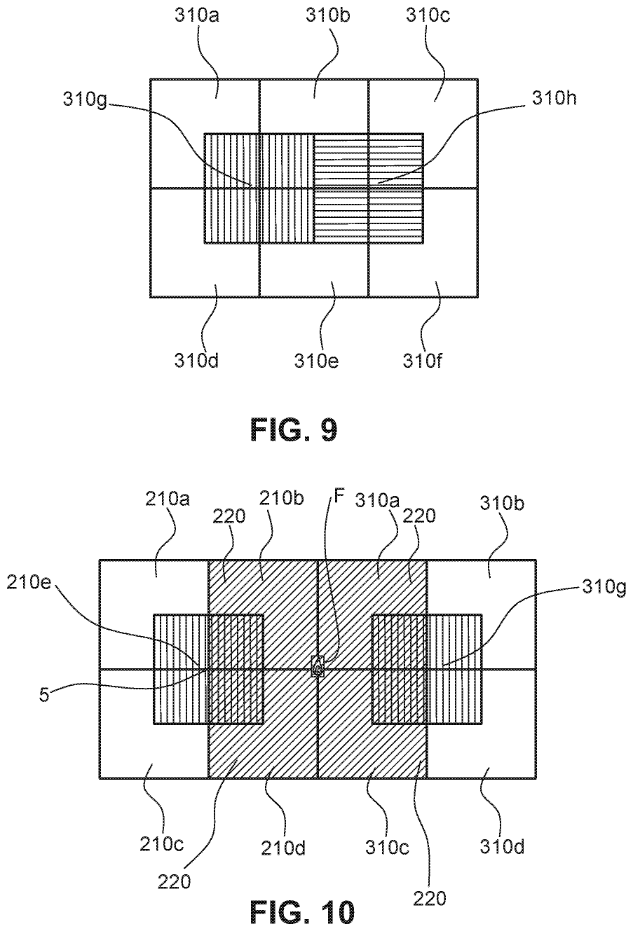

FIG. 9 a schematic view of a second example of zones in a room,

FIG. 10 a schematic view of a third example of zones in a room,

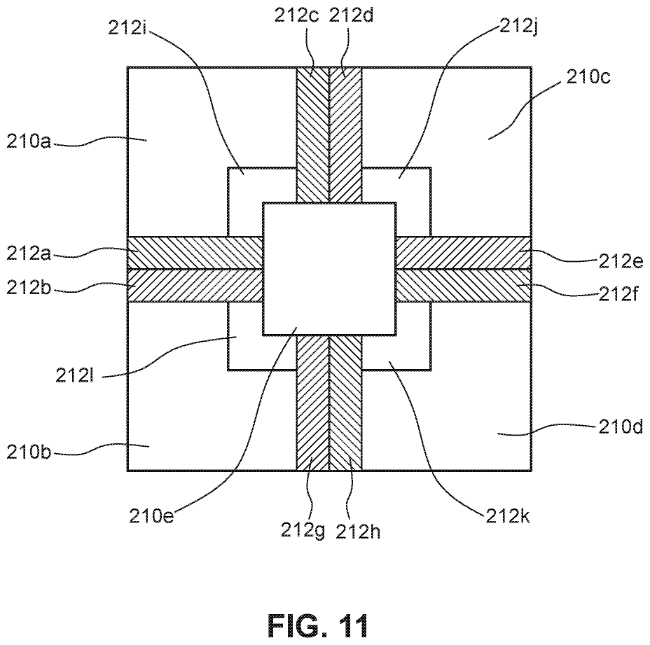

FIG. 11 a schematic view of a fourth example of zones in a room,

FIG. 12 a perspective view of an embodiment of a fire locator device,

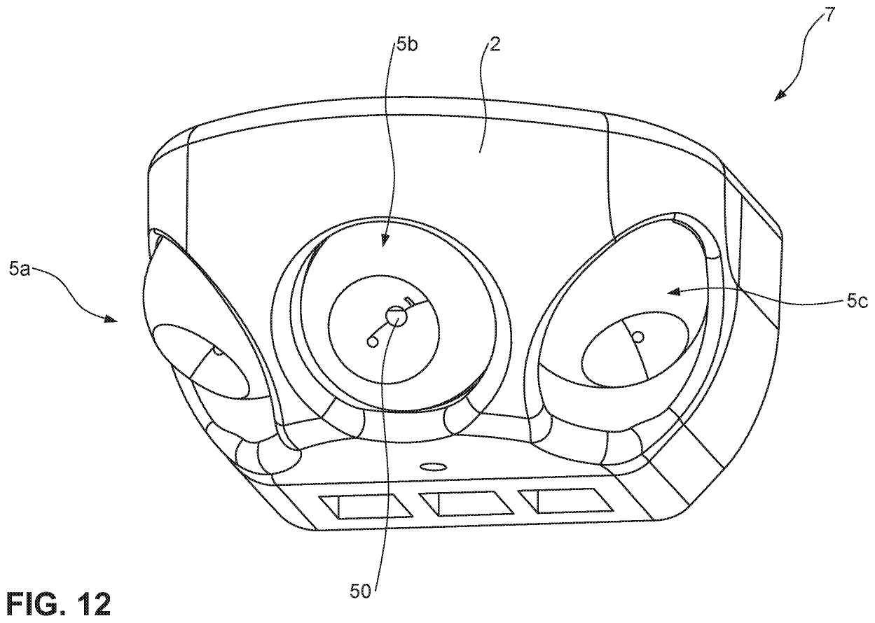

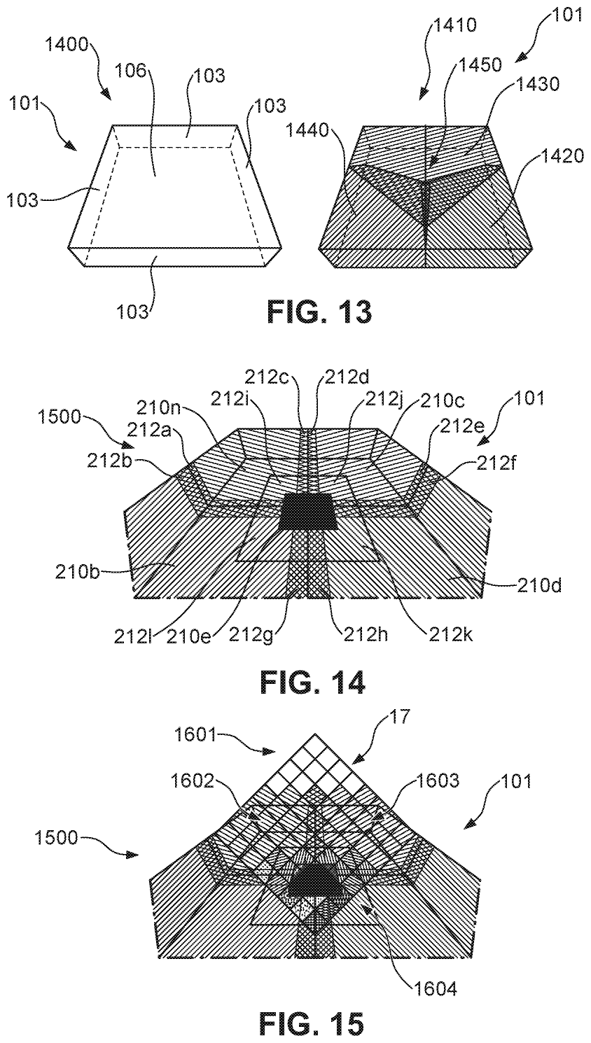

FIG. 13 perspective views of a room,

FIG. 14 a perspective view of zones in a room,

FIG. 15 a mapping between zones and the pixel grid, and

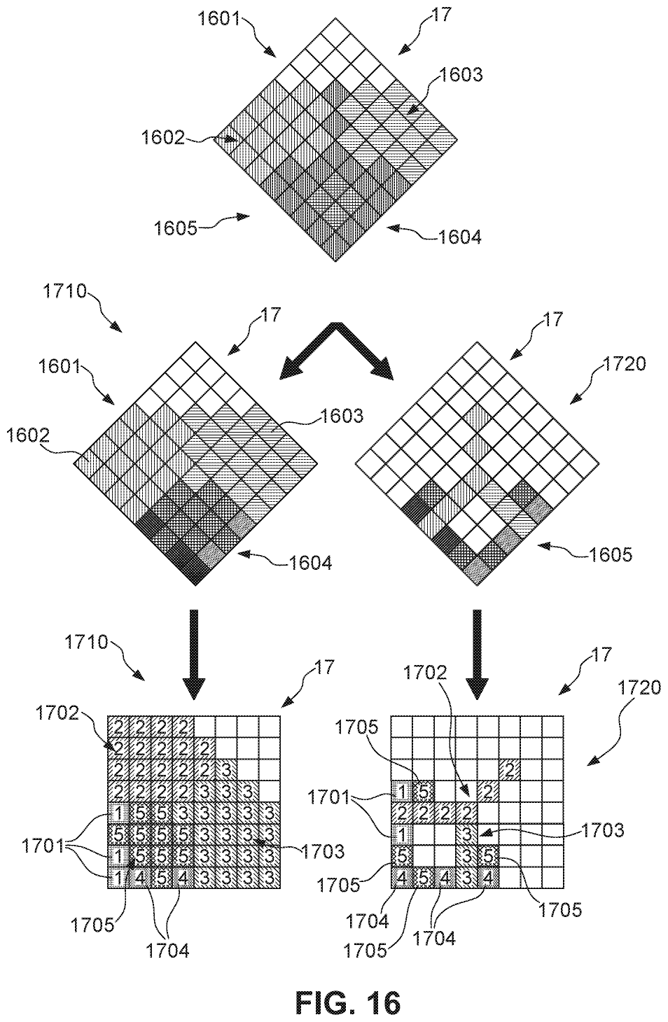

FIG. 16 a further example of a mapping between zones and the pixel grid.

FIG. 1 schematically and exemplarily illustrates a layout of a fire locator device 7 of a fire fighting system 1 according to the present invention. The fire locator device 7 comprises a controller which is arranged to communicate with a plurality of further components of the fire locator device 7. Internally, fire locator device 7 comprises a watchdog timer 90 which validates the operability of controller 9, a memory 93, which is configured to store inter alia documentation and other computer instructions intended to be executed by controller 9 on a mainboard 92. Mainboard 92 further comprises at least one, in this example three, interfaces 94, which are configured to communicate with one of respective sensor components 5a, 5b and 5c.

Mainboard 92 further comprises a power interface 95, which is configured to be connected to a power supply 78, such as a mains connection. Further, a serial interface 96, such as an USB interface, designed to communicate with, for instance, a computer, is provided. Finally, a maintenance button 98 is provided, with which a maintenance mode can be activated, for instance.

Fire locator device 7 is further adapted to indicate its status using a status indicator 72, a maintenance indicator 74 and an acoustical indicator 76, for instance. The status indicator 72 and the maintenance indicator 74 can also be arranged in the same indicator, such as a single RGB-LED. Also other implementations are of course feasible. Acoustical indicator 76 can, for instance, indicate acoustically in case a fire is located by fire locator device 7.

Fire locator device 7 is configured to communicate with a fire detection device 6, such as a smoke detector, which is provided external to fire locator device 7. Most importantly, fire locator device 7 in general is only configured to activate one or more out of fire fighting devices 3a, 3b, 3c, 3d and/or 3e in case fire detection device 6 confirms the presence of a fire, for instance detects smoke. In one example, each of fire fighting devices 3a, 3b, 3c, 3d and/or 3e comprises a relays or different interface, which is configured to communicate with controller 9. Fire detection device 6 is communicating with controller 9 by means of a connection 62, which can be provided as a wire or wirelessly.

Each of the sensor components 5a, 5b and 5c comprises an array sensor 50 having a plurality of thermopile elements as sensor elements, a heating element 52 and an interface 54. Heating element 52 is part of self-test component and is configured to heat array sensor 50 in order to evaluate the sensor signal in response to the heating. In case at least one of the sensor elements of array sensor 50 is inoperable, a deviation of the expected signal response can be detected. Thus, it can reliably be detected that each of sensor component 5a, 5b, 5c is operating normally. The triggering of the self-testing of sensor component 5a, 5b and 5c is preferentially conducted or initiated by controller 9, while it can also automatically be initiated by a dedicated circuitry provided with each of sensor components 5a, 5b and 5c.

Preferentially, heating element 52 is provided at a suitable position touching the sensors case to optimally heat up the sensor component. In other examples, the heating element 52 is provided at a suitable position in front of array sensor 50 or a transition component is provided, which is capable of moving heating element 52 to its operating position in front of or in proximity of array sensor 50 in case the self-testing is performed. In either case it is advantages that heating element 52 does not obstruct portions of the feel of view of array sensor 50, which could lead to less accurate localization results. Interface 54 is configured to provide the sensor signals originating from array sensor 50 to controller 9 and can further be configured to communicate or initiate signals relating to operation of heating element 52, i.e. to the self-testing functionality.

In case at least one of the sensor elements of array sensor 50 indicates the presence of a fire, i.e. provides a signal value exceeding a predefined threshold, and, at the same time, fire detection device 6 indicates the presence of a fire, controller 9 is configured to open at least one of valve 32 connected to at least one of fire fighting devices 3a, 3b, 3c, 3d and/or 3e. Fire fighting devices 3a to 3e are not part of fire locator device 7 but are comprised in a system 1 for fire fighting, which will also be described with respect to the further figures. Expressed differently, the fire fighting devices 3a, 3b, 3c, 3d and 3e can be provided separate and distant from fire locator device 7, while it is of sole importance that controller 9 is capable of activating the respective fire fighting device 3a to 3e, if required.

FIG. 1 further illustrates a thermistor 8, which is configured to determine a temperature within the area of operation. Thermistor 8 can be integrally formed with fire locator device 7 and provide an internal temperature thereof. Additionally, or alternatively, it can be arranged outside a housing of fire locator device 7 and provide an external temperature thereof. Further additionally or alternatively, thermistor 8 can be located remote from the further components of fire locator device 7, for instance at another location within the area of operation. In summary, thermistor 8 is configured to determine a temperature within the area of operation, which can be employed to further increase the reliability of the system. As further described below, the provision of thermistor 8 can ensure a double interlock system even in case one of the further components of system 1 fails.

In order to determine which of fire fighting devices 3a to 3e is to be activated by controller 9, a mapping between sensor elements of array sensors 50 and zones of the area of operation, which is monitored by fire locator device 7 is determined or provided. Further, each of fire fighting devices 3a to 3e is associated with one of these zones, respectively. An example of the determination of zones and the association with respective sensor elements will be described below with reference to, for instance, FIGS. 7 to 11 and 13 to 15.

FIG. 2 schematically and exemplarily illustrates a flow chart of an operation of the fire locator device 7 shown in FIG. 1. In this exemplary flow chart, it is expected that all sensor components 5a, 5b and 5c operate normally and without error. In a step S200, signals of sensor components 5a, 5b and 5c are subjected to a step called pixel masking. Pixel masking compares each individual signal value of each sensor element of the array sensors 50 of the respective sensor components 5a, 5b, 5c with an individual signal value threshold. The threshold may be the same for all sensor elements, but can also be individually assigned or adapted to the respective location, which is observed by the respective sensor element. For instance, at the location the respective sensor element monitors a higher than usual temperature is expected, the threshold value will be set to a higher value, such that the standard temperature expected at the respective location does not trigger the fire alarm signal. For reasons it is also possible not only to increase or decrease the thresholds, but also to completely ignore the sensor element, which is referred to as masking. One of these examples can be, for instance, a kitchen having a cooking hob, an oven or even a candle. After having subjected the signal values to step S200, i.e. to pixel masking, in a step S205 is evaluated whether the pixel values exceed the corresponding threshold. In the negative, i.e. in case sensor elements have signals lower than their respective threshold, the operating status is set to normal, i.e. a step S210. To the contrary, in case at least one of the sensor elements exceeds the respective threshold, a status is set to alarm in step S220 and a mapping is conducted between the pixel, i.e. the sensor element, to the spatial position within the area of operation observed in a step S230. The mapping is performed in order to determine which of fire fighting devices 3a to 3e is to be activated in response.

Then, in a step S235, the double interlock is performed, in other words, it is determined whether the signal is a true fire. To this end, an output of fire detection device 6 is additionally considered. Only in case fire detection device 6 additionally indicates the present of a fire, step S240 is executed, leading to an activation of at least one of the fire fighting devices 3a to 3e. Thus, the fire fighting is initiated.

FIG. 3 schematically and exemplarily illustrates perspective views of a housing 2 of fire locator device 7 as described above. Housing 2 comprises side surfaces 2a, 2b, 2c, at top surface 2d, a bottom surface 2e and a mounting extension 2f and rear surface 2g. At the front end side surfaces 2a, 2b, 2c openings for respective sensor components 5a, 5b, 5c and fire fighting devices 3a to 3e can be seen. While in this example one housing 2 comprises openings for also the fire fighting devices, it is contemplated that the fire fighting devices can be provided at a different housing separate from housing 2. The arrangement of in particular the side surfaces 2a, 2b, 2c allows for the sensor components 5a, 5b, 5c to observe or monitor a large area of operation when housing 2 is mounted at a wall or sealing of a monitoring space, such as a room of a building.

FIG. 4 schematically and exemplarily illustrates a control structure and hydraulics, such as pipes and valves, of a fire locator device 7 of fire fighting system 1. It can be seen that a fire fighting agent valve 4 is provided, which connects fire fighting agent, for instance coming from a piping installation, with valves 32 of each of the respective fire fighting devices 3a to 3f. The three sensor components 5a, 5b, 5c are arranged substantially among the fire fighting devices 3a to 3e such that a broad angle of view can be monitored. In particular, the distribution of fire fighting devices 3a to 3e and sensor components 5a to 5c is such that coverage of the space or room to be monitored is optimized. It can be seen that both fire fighting agent valve 4 and valves 32 of each of the respective fire fighting devices 3a to 3e are in communicating connection with processor or controller 9, which activate each of the respective valves in case both the fire detection device 6 and at least one of sensor components 5a to 5c indicates presence of a fire. As further described in detail below, the double interlock activation can additionally or alternatively be employed using a temperature detected by thermistor 8.

FIG. 5 shows a fire fighting system 1. The fire fighting system 1 is installed in a room 101 of a building 100. The room comprises a number of side walls 103, a ceiling 105 and a floor 106. Inside the room 101, a heat source 107 is installed.

The room 101 is an example for an area of operation protected by the fire fighting device.

It should be noted that, while an entire room 101 is illustrated in FIG. 5 and some of the consecutive figures, the system according to the invention can also be provided to protect only a part of the room. In this case, also a plurality of systems 1 according to the invention can be provided to protect the entire room. Thus, a room according to this invention is used as a defined area of operation under protection by fire fighting system 1, which can also be a part of a physical room, i.e. a construction being enclosed by walls and ceiling.

The system 1 comprises a number of fire fighting devices 3a, b which are installed for example under the ceiling 105 of the room 101, but could alternatively also be wall-mounted. The fire fighting devices 3a, b may for example be open fire fighting nozzles of a deluge system.

The system 1 further comprises a plurality of fire detection devices 6 installed in the room 101, for example under the ceiling 105 and/or on one of the side walls 103. While a plurality of fire detection devices 6 is illustrated in FIG. 5, it should be noted that also a single fire detection device is sufficient in other examples.

The system 1 further comprises a fire locator device 7 that is configured to locate a fire F in the room 101. The fire detector devices 6 are configured to detect the presence of a fire in the room 101. The fire fighting devices 3a, b are each positioned such that they distribute fire fighting agent within a respective coverage zone 11a, b (hereinafter also “zone”) of the room 101. The zones 11a, b may overlap.

System 1 further comprises a controller 9 which is in signal communication with the fire fighting devices 3a, b with the fire detection devices 6 and with the fire locator device 7. The controller 9 is configured to activate the fire fighting devices 3a, b in reaction to a detection of the fire F as is detailed further herein below.

Each of the sensor components 5a, 5b, 5c of the fire locator device 7, which was described in detail with reference to FIG. 4, comprises an array sensor 50 (FIGS. 7a, b) which has a defined field of view having a first view angle α1 and a second view angle α2 (FIG. 6). Within its field of view, the array sensor 50 is adapted to monitor a predetermined area, or zone, of the area of operation, e.g. of room 101. The array sensor 50 comprises a sensor array 15 having a plurality of n×m pixels arranged in a grid 17. Since the fire locator device 7 is stationary, i.e. fixedly installed in the room 101, once oriented, each of the pixels of the grid 17 is specifically assigned to a specific portion of the room 101. Depending on the distance of the fire locator device 7 from e.g. the floor 106 of the room 101 and depending on the specific view angles α1, α2, the grid 17 of pixels defines a projection 13 of the pixel grid 17 in the room 101. A fire F which lies within this projection 13 will be determined by the grid 17 of the sensor array 15.

Preferably, the sensor array 15 is an infrared sensor array, in particular a thermopile array. The array sensor 50 is configured to generate for each pixel a signal representative for a temperature within the portion of the projection 13 in the room 101. The fire F will cause representative temperature signals to be generated by the array sensor 50. The controller 9 is configured to receive the representative temperature signals from the array sensor 50. Also, the controller 9 is configured to allocate specific threshold values T₁, T₂ to each pixel of the sensor array 15. There may be one, two or more different threshold values used across the array. According to the invention, it is possible to designate a threshold value that will be reached only in case of a fire, or not be reached at all, the latter being especially useful to permanently “blind” the array sensor from certain stationary hot spots that are indicative of non-hazardous fire related heat sources. More specifically, it is even possible to “blind” individual pixels of the sensor array 15 and thus keep the area, which is “excluded”, to a minimum area around the stationary hot spots.

However, each threshold value may also be indicative of a temperature limit, the breach of which happens only in case of a fire in that specific portion of the room. As soon as the temperature in the pixels of the sensor array 15 exceeds the predetermined threshold levels T₁, T₂ indicative of a fire, the controller not only has identified the presence of a fire F in the room 101, but additionally has located the portion within the projection 13 (FIG. 5) where the fire F resides by identifying the respective hot spot among the grid 17 (FIG. 7b) of pixels. This allows for very efficient allocation of the fire fighting device 3a or 3b that is ideally positioned to distribute fire fighting agent in the zone where the fire F has been located.

Depending on whether the fire has been located in a zone that is overlapped by the zones 11a, b covered by a plurality of fire fighting devices 3a, b, the controller 9 may also activate more than one fire fighting device 3a, b, but ideally no more than two fire fighting devices 3a, b.

In many rooms, in particular residential rooms, it is to be expected that stationary heat sources such as heat source 107 are present in a portion monitored by the fire locator device 7. In order to prevent false fire alarms, and in order to prevent inaccurate location of actual fires due to the influence of stationary heat sources, the controller 9 is configured to assign specific threshold values T₂ to all pixels which are within range of the stationary hot spot 109 formed by the stationary heat source 107. As is depicted in FIG. 6 and FIG. 7b, the controller 9 could for example be programmed to assign a higher threshold value T₂ to pixels 49 through 54 and 57 through 62, while assigning a lower threshold value T₁ to the remaining pixels of the grid 17. By doing so, increased temperatures emanating from heat source 107 would not be flagged as hotspots indicative of a fire F, unless the predetermined higher threshold value T₂ is exceeded.

This allows the controller 9 to distinguish between a fire F and a fire-unrelated or non-hazardous-fire heat source NF. Basically, any number of stationary heat sources may be accounted for in this way.

While the embodiments of FIG. 5 through 7b show a simple set-up of a room 101 having only one fire locator device, the invention also covers embodiments wherein the room 101, either due to its size or due to its complexity of its layout, requires the use of more than one fire locator device. Preferably, the entire floor 106 of the room is covered by grids 17 of pixels emanating from specifically mounted and oriented fire locator devices 7. Depending on economic factors and ease of installation, the number of fire locator devices for the size of the grid 17 of pixels for each fire locator device 7 may be modified according to need. At any rate, the invention allows for the use of array sensors 50 having sensor arrays 15 with comparatively low resolution (in particular when compared to prior art systems using high-res infrared camera systems).

FIGS. 8 to 11 schematically and exemplarily illustrate different configurations or distributions of zones 210a-210e or 310a-310h in different rooms, respectively.

FIG. 8 illustrates a layout of four zones 210a-210d, which are equal in size and apportion the surface area of the room among them. In other words, the four zones 210a-210d cover the entire surface area, i.e. the floor and—if necessary—at least part of the wall surface area of the room. A further, fifth zone 210e is located in the center of the room and overlays all of the other four zones in the center of the room. Fifth zone 210e is thus redundant and provided to limit the spatial extension and also the amount of the fire fighting agent dispersion.

In FIG. 8, four examples of a fire F at different locations within the illustrated room, i.e. within different zones 210a-210e, are illustrated. Each of the examples of the fire F leads to the determination of a fire fighting area 220 by the controller 9, which is as follows. In the first example, since the fire F is located within zone 210a, the fire fighting area is determined to be comprised of zone 210a. In the second example, the fire F is located at the edge between zone 210a and zone 210b, such that both zone 210a and zone 210b are determined as the fire fighting area 220. The third example shows the fire F in the center of the room. In this example, only zone 210e is determined as fire fighting area 220. In the last example, the fire F is located close to the center within zone 210b. Thus, both the central zone 210e and zone 210b are determined as fire fighting area 220. In these examples, for the reasons discussed above, it is preferred that not more than two zones 210a-210e be determined as fire fighting area 220.

In this example, both the room and each of the respective zones 210a-210e are of quadratic shape for the ease of illustration, while of course also different examples of shapes are contemplated. The quadratic shape is particularly beneficial in combination with specific controllable nozzles as fire fighting devices, e.g. fire fighting device 3a-3e, such as a Viking Model A full cone nozzle or a similarly operating, publically available nozzle.

FIG. 9 substantially corresponds to the example of FIG. 8, wherein the room as an example of an area of operation—or likewise a part of the room—is rectangular and its surface is distributed among six zones 310a-310f, which are also in this example quadratic and of equal size. Two central zones 310g and 310h are respectively provided to overlap four adjacent of the zones 310a-310f, respectively. The determination of a fire fighting area 220 is performed analogous to the example of FIG. 9. In other word, not more than two zones 310a-310h are determined to be part of the fire fighting area (not shown in FIG. 5) at the time.

FIG. 10 schematically illustrates a further example, wherein the room is split into two substantially independent regions of five zones 210a-210e, 310a-310d and 310g, respectively. For examples, each of the two groups of five zones can be coordinated and controlled by a particular, individual controller 9 and/or fire locator device 7. In other examples, the two groups can also be controlled commonly by a single controller 9 and/or fire locator device 7.

In the example of FIG. 10, the two fully overlapping regions 210e, 310g are not adjacent to each other, different from the example of FIG. 9, in which two completely overlapping zones 310g, 310h are adjacent to each other. In the example of FIG. a fire F is illustrated in the center of the room. In this example, the fire fighting area 220 is extended to include two zones 210b, 210d, and 310a, 310c of each of the first and second group of zones 210, 310, respectively.

Accordingly, in this example also the situation, in which more than two zones are comprised in the fire fighting area 220 is illustrated. The example of FIG. 10 is particularly useful in case two substantially independent systems for fire fighting are arranged in the same room. In this case, two zones per independent system are comprised in the fire fighting area 220, respectively. Then, again, not more than two zones will be activated concurrently, i.e. designated as the fire fighting area 220

It is of course contemplated that also in the example of FIG. 10 a further fully overlapping zone can be defined in between the zones 210e and 310g. In this particular case, it would be beneficial to protect the entire room as illustrated in FIG. 10 with a single system for fire fighting according to the invention.

FIG. 11 schematically and exemplarily illustrates the effect of overlapping zones in the example of five zones 210a-210e. In this example, overlapping regions 212a-212k are formed in the overlapping area between two adjacent zones 210a-210e, respectively.

Overlapping regions 212a and 212b correspond to the region in which zone 210a overlaps zone 210b and vice versa. Accordingly, the fire fighting area 220 in case a fire F is detected in either region 212a or region 212b will be comprised of both zone 210a and 210b. Likewise, in overlapping regions 212c and 212d zones 210a and 210c will form the fire fighting area 220. A fire F in overlapping region 212e or 212f will yield a fire fighting area 220 with zones 210c and 210d, while a fire F in overlapping region 212g or 212h will result in fire fighting area 220 being formed of zones 210b and 210d.

Finally, in case a fire is present in the outer region of zone 210e, i.e. the region near the edge of zone 210e, which are indicated with 212i, 212j, 212k or 212l, the fire fighting area 220 is formed of zone 210e and one of zones 210a-210d, respectively. Thus, also in this example with overlapping regions, it can be ensured that not more than two zones will be comprised in the fire fighting area 220 at the same time.

FIG. 12 illustrates a perspective view of an embodiment of a fire locator device 7 with a different shape of housing 2. The three sensor components 5a, 5b, 5c are provided in circular indentations of housing 2 and protrude therefrom with a substantially hemispherical form. Each of the respective casing or housing of the sensor components 5a, 5b, 5c comprises a conical well, wherein at the bottom of each well the array sensor 50 is located. The opening angle of the corresponding conical well corresponds to the field of view of the array sensor 50. In this embodiment, the fire fighting devices 3a-3e are external from the fire locator device 7 and not illustrated.

FIG. 13 illustrates perspective views 1400, 1410 of room 101 as an example of the area of operation. In view 1400, the exemplary quadratic layout of room 101 including floor 106 and side walls 103 can be seen. In view 1410, the field of view of a fire locator device 7 having three sensor components, for instance fire locator device 7 of FIG. 12, is illustrated. A field of view 1420, a field of view 1430 and a field of view 1440 corresponds to one respective of sensor components 5a, 5b, and 5c.

It can be seen that the entire surface of the room 101 is imaged by at least one of the sensor components 5a, 5b, 5c, i.e. the fields of view 1420, 1430, 1440 completely fill the area of the room 101. In central areas 1450, the fields of view of different sensor components partially overlap.

FIG. 14 schematically illustrates room 101, in which the five zones 210a-210e and overlapping regions 212a-212k as illustrated in FIG. 11 are illustrated in a perspective view 1500.

FIG. 15 illustrates an overlay of FIG. 14 with the imaging areas of the sensor components, wherein a projection of the pixel grid 17 of the sensor elements of sensor component 5b is provided as an overlay over zones 210-210e. Only the pixel grid 17 of sensor component 5b is illustrated, wherein the mapping between zones 210a-210e and sensor elements of the respective sensor component is likewise determined for sensor component 5a and 5c.

Sensor elements corresponding to a region 1601 will not be mapped to any of zones 210a-210e, since they image an area outside the area of observation. Sensor elements corresponding to a region 1602 will be mapped to zone 210a, region 1603 will be mapped to zone 210c and the further sensor elements corresponding to a region 1604 will be mapped to one or more of zones 210b, 210d and 210e.

FIG. 16 schematically and exemplarily illustrates a further example of a mapping between a projection of the pixel grid 17 and the zones 210a-210e. In the example of FIG. 16, in addition to regions 1601, 1602, 1603, and 1604, pixels 1605 illustrated as cross-hatched pixels are located at an edge of the regions 1601-1604, respectively, and are assigned to two zones.

The projection matrix is therefore split into a primary projection or assignment matrix 1710 illustrating regions 1601-1604, and a secondary projection or assignment matrix 1720, which contains the double-assigned pixels 1605 only.

Both primary and secondary assignment matrices 1710 and 1720 can then be rotated, in the example by 45°, to facilitate machine-readability since the pixels are arranged in rows and columns. Finally, pixels 1701 both of the primary and secondary assignment matrices 1710 and 1720 is assigned to zone 210b. Pixels 1702 correspondingly to zone 210a, pixels 1703 to zone 210c, pixels 1704 to zone 210d, and pixels 1705 to zone 210e. Accordingly, in the example according to FIG. 16, several pixels, i.e. pixels 1605, are assigned to more than one zone.

### LIST OF REFERENCE SIGNS

1 system
2 housing
2a,b,c side surface
2d top surface
2e bottom surface
2f mounting extension
2g rear surface
3a,b,c,d,e fire fighting device
32 valve
4 fire fighting agent valve
5a,b,c sensor component
50 array sensor
52 heating element
54 interface
6 fire detection device
7 fire locator device
72 status indicator
74 maintenance indicator
76 acoustical indicator
78 power supply
8 thermistor
9 controller
90 watchdog timer
92 mainboard
93 memory
94 interface
95 power interface
96 serial interface (USB)
98 maintenance button
11a,b zone
13 projection of pixel grid
15 array
17 pixel grid
100 building
101 room
103 side wall
105 ceiling
106 floor
107 heat source
109 stationary hot spot
210a-e zone
212a-l overlapping region
220 fire fighting area
310a-h zone
1400, 1410 perspective views of the room
1420, 1430, 1440 field of view of sensor component
1450 central area
1500 perspective view
1601, 1602, 1603, 1604 region of pixel grid
1605 double-zone assigned pixels
1701 pixels assigned to zone 210b
1702 pixels assigned to zone 210a
1703 pixels assigned to zone 210c
1704 pixels assigned to zone 210d
1705 pixels assigned to zone 210e
1710 primary assignment matrix
1720 secondary assignment matrix
m, n grid parameters
F fire
NF fire-unrelated heat source or non-hazardous fire
T₁, T₂ threshold
α₁, α₂, α₃ angle, field of view

1. A method of operating a fire fighting system, the fire fighting system comprising:
a fire locator device, and
a plurality of stationary fire fighting devices, each associated with and configured to distribute fire fighting agent within a respective zone of an area of operation,
wherein the fire locator device comprises:
at least one housing configured to be mounted within or in proximity of the area of operation,
a plurality of sensor components, wherein each sensor component of the plurality of sensor components comprises a plurality of sensor elements sensitive to radiation in a matrix arrangement, and
a controller configured to receive sensor signals from the plurality of sensor components for determining a location of a fire within the area of operation, the method comprising:
associating each sensor element of the sensor components of the fire locator device to at most two zones of the area of operation.

2. The method according to claim 1, wherein the step of associating comprises a step of providing a primary matrix and optionally a secondary matrix, wherein each element of the primary and secondary matrices provides a correspondence between one of the sensor elements of the sensor component and one of the zones.

3. The method according to claim 1, further comprising:
sequentially comparing each of the sensor signals from the sensor elements with a corresponding signal threshold,
identifying the zone of the area of operation in case at least one of the sensor signals exceeds the corresponding signal threshold, and
activating the at least one fire fighting device associated with the located zone.

4. The method according to claim 3, wherein at most two zones out of the plurality of zones are activated.

5. The method according to claim 3, wherein the activation of zones is performed according to a sequence of sensor elements exceeding the corresponding signal threshold.

6. A method of configuring at least one fire locator device for fighting a fire in an area of operation of a building, the fire locator device comprising:
at least one housing configured to be mounted within or in proximity of the area of operation,
a plurality of sensor components, wherein each sensor component of the plurality of sensor components comprises a plurality of sensor elements in a matrix arrangement, wherein the sensor elements are sensitive to radiation and each sensor component covers a field of view of a certain shape, the field of view having a central axis, and
a controller configured to receive sensor signals from the plurality of sensor components for determining a location of a fire within the area of operation, wherein the method comprises:
providing a geometry of the area of operation, and
determining, based on the provided geometry, at least one of
a) a position of the fire locator device within or in proximity of the area of operation, and
b) a location and an orientation of the plurality of sensor components within the at least one housing such that a monitoring coverage fulfils a predetermined criterion.

7. The method according to claim 6, wherein each of the central axes of the plurality of sensor components spans an angle of at least 10° with a vertical axis.

8. The method according to claim 6, the predetermined criterion exceeding a threshold of at least 90%.

9. The method according to claim 6, wherein a number of fire locator devices and corresponding positions of the fire locator devices within the area of operation, respectively, are determined such that the monitoring coverage fulfils the predetermined criterion.

10. The method according to claim 6, wherein a height of the position of the at least one fire locator device over a floor of the area of operation is determined depending on the geometry of the area of operation or an extension of the area of operation, wherein the height is determined to be in the range of between 1.94 m and 2.74 m.

11. The method according to claim 6, wherein the central axes of all sensor components of one fire locator device are unique, and wherein an angle between any two of the central axes exceeds a predetermined threshold of 20°.

12. The method according to claim 6, wherein all of the sensor components are arranged in a substantially horizontal plane, wherein one of the sensor components is arranged closer to a front of the housing than the other sensor components.

13. The method according to claim 6, wherein the locations and orientations of the sensor components are determined so as to minimize a change of the monitoring coverage with regard to deviations of the real housing position from the determined housing position.

14. The method according to claim 6, wherein each sensor component for each fire locator device comprises a predetermined angle of view, wherein a number of sensor components for each fire locator device is determined so that the sum of predetermined angles of view exceeds 180°, or the number is determined to be three, wherein each sensor component further comprises a thermopile array sensor having more than 4×4 pixels or at least 8×8 pixels, which forms the sensor elements.

15. The method according to claim 6, further comprising the step of
defining a signal threshold for each of the sensor elements of the plurality of sensor components, wherein a signal value exceeding the signal threshold is indicative of a fire, wherein an individual signal threshold is assigned to each of the sensor elements, respectively.

16. The method according to claim 6, further comprising a step of associating each sensor element of the sensor components of the fire locator device to at most two zones of the area of operation.

17. The method according to claim 1, further comprising a step of defining objects in the area of operation including defining a dimension of the objects, wherein the number and position of the at least one fire locator device is determined based on the objects.

18. The method according to claim 17, further comprising the step of corresponding at least one of the sensor elements with each of the objects.

19. The method according to claim 17, wherein the objects comprise at least one hot object or non-hazardous fire, wherein a signal threshold for each of the sensor elements corresponding to the hot object or the non-hazardous fire is increased.

20. The method according to claim 1, further comprising a step of modifying, by a user using an interface or a graphical display, of at least one of a configuration and a position of at least one of the defined fire locator devices, wherein a visual feedback of the change in monitoring coverage based on the modification is provided to the user.

21. A fire fighting system, comprising:
a fire locator device, and
a plurality of stationary fire fighting devices, each associated with and configured to distribute fire fighting agent within a respective zone of an area of operation, wherein the fire locator device comprises:
at least one housing configured to be mounted at a certain height within or in proximity of the area of operation,
a plurality of sensor components, wherein each sensor component of the plurality of sensor components comprises a plurality of sensor elements sensitive to radiation in a matrix arrangement, and
a controller configured to receive sensor signals from the plurality of sensor components for determining a location of a fire within the area of operation, the system comprising a controller configured to associate each sensor element of the sensor components of the fire locator device to at most two zones of the area of operation.
